(19) United States
(12) Patent Application Publication
(10) Pub. No.: US 2012/0176363 A1
(43) Pub. Date: Jul. 12, 2012

(54) MOBILE TERMINAL, STORAGE MEDIUM STORING LIST CREATING PROGRAM AND LIST CREATING METHOD

(75) Inventor: Munehito Matsuda, Daito-shi (JP)

(73) Assignee: KYOCERA CORPORATION, Kyoto (JP)

(21) Appl. No.: 13/497,777

(22) PCT Filed: Sep. 2, 2010
(86) PCT No.: PCT/JP2010/064992

§ 371 Date: Mar. 22, 2012

(30) Foreign Application Priority Data
Sep. 28, 2009 (JP) 2009-221855

(51) Int. Cl. G06T 1/00

(52) U.S. Cl. 345/418

(57) ABSTRACT

A mobile terminal 10 has a flash memory 28 for storing image data and a display 26 for displaying an image based on image data. If the image switching function is executed in accordance with the opening and closing of a slide in the mobile terminal 10, the processor 20 switches the image that is being displayed on the display 26 on the basis of a random list. Then, the processor 20 creates the random list such that each of a plurality of images that is stored in a setting folder is sure to be selected once.

### TECHNICAL FIELD

The present invention relates to a mobile terminal, a storage medium storing a list creating program and a list creating method. More specifically, the present invention relates to a storage medium storing a list creating program and a list creating method that are able to display a plurality of images.

### BACKGROUND ART

Conventionally, mobile terminals capable of displaying a plurality of images have been known. The mobile communication terminal has an opening and closing detector for detecting a change of state between a folded state and an opened state, a displayer for displaying image data, etc., a storage for storing a plurality of sets of image data and a controller for entirely controlling the mobile communication terminal. When the opening and closing detector detects the change of state, one of the plurality of sets of image data stored in the storage is selected in order or randomly by the controller and is displayed on the displayer.

### SUMMARY OF THE INVENTION

### Problems to be Solved by the Invention

However, in the mobile communication terminal of the background art, the order of the image data to be switched is random, and therefore, the same image data may be continuously displayed, or image data which has never been displayed may exist. Thus, a user may feel dissatisfied with the randomly switching image data.

Therefore, it is a primary object of the present invention to provide a novel mobile terminal, storage medium storing a list creating program and list creating method.

Another object of the present invention is to provide a mobile terminal, a storage medium storing a list creating program and a list creating method that randomly switch images and make a user feel satisfied.

### Means for Solving the Problems

The present invention employs following features in order to solve the above-described problems. It should be noted that reference numerals and the supplements inside the parentheses show one example of a corresponding relationship with the embodiments described later for easy understanding of the present invention, and do not limit the present invention.

A first invention is a mobile terminal having a storage for storing a plurality of image data and a displayer for displaying images, and displaying the plurality of image data on the basis of a list representing a displaying order of the plurality of image data, comprising a setter which randomly sets the displaying order of the plurality of image data such that each of the plurality of image data is selected once, and a creator which creates the list on the basis of the displaying order set by the setter.

In the first invention, a mobile terminal (10) displays a plurality of image data stored in a storage (28) such as a flash memory, etc. on a displayer (26) such as a display, etc. on the basis of a list (336) representing a displaying order. A setter (20, S83, S93, S95) randomly sets the displaying order by setting arithmetic progression including random numbers allowing a plurality of image data to be sure to be selected once according to time random number processing, etc. A creator (20, S85, S97) creates the list on the basis of the displaying order randomly set.

According to the first invention, each of the plurality of image data is sure to be selected once, and therefore, it is possible to make the user feel satisfied by randomly switching the images.

A second invention is according to the first invention, wherein the setter includes a first setter which sets to prevent a number that stands last on a list previously created from being set to a first on a list currently created and a second setter which sets the displaying order such that each of the plurality of image data is selected from numbers other than the number set by the first setter.

In the second invention, a first setter (20, S93) sets a first of the displaying order such that a number that stands last on a list previously created is not set to a first on a list currently created so as to prevent the same image from being successively displayed. A second setter (20, S95) sets random numbers such that each of the plurality of image data is selected from numbers other than the number set at first.

According to the second invention, it is possible to switch the images in a random order without the same image being displayed successively.

A third invention is a storage medium storing, readably to a processor (20) of a mobile terminal (10), a list creating program of the mobile terminal (10) having a storage (28) for storing a plurality of image data and a displayer (26) for displaying images, and displaying the plurality of image data on the basis of a list representing a displaying order of the plurality of image data, the list creating program causes the processor (20) to function as: a setter (S83, S93, S95) which randomly sets the displaying order of the plurality of image data such that each of the plurality of image data is selected once, and a creator (S85, S97) which creates the list on the basis of the displaying order set by the setter.

In the third invention as well, each of the plurality of image data is sure to be selected once similar to the first invention, and therefore, it is possible to make the user feel satisfied by randomly switching the images.

A fourth invention is a list creating method of a mobile terminal (10) having a storage (28) for storing a plurality of image data and a displayer (26) for displaying images, and displaying the plurality of image data on the basis of a list representing a displaying order of the plurality of image data, comprising: randomly setting the displaying order of the plurality of image data such that each of the plurality of image data is selected once (S83, S93, S95), and creating the list on the basis of the displaying order (S85, S97).

In the fourth invention as well, each of the plurality of image data is sure to be selected once similar to the first invention, and therefore, it is possible to make the user feel satisfied by randomly switching the images.

According to the present invention, each of the plurality of image data is sure to be selected once, and therefore, it is possible to make the user feel satisfied by randomly switching the images.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an electric configuration of a mobile terminal of one embodiment of the present invention.

FIG. 2 is an illustrative view showing one example of an appearance of the mobile terminal shown in FIG. 1.

FIG. 3 is an illustrative view showing one example of a plurality of image data to be stored in a flash memory shown in FIG. 1.

FIG. 4 is an illustrative view showing one example of a setting list stored in an SDRAM shown in FIG. 1.

FIG. 5 is an illustrative view showing one example of a random list created based on the setting list shown in FIG. 4.

FIG. 6 is an illustrative view showing one example of display data expanded in a cache shown in FIG. 1.

FIG. 7 is an illustrative view showing one example of images displayed on a display shown in FIG. 1.

FIG. 8 is an illustrative view showing one example of a process of re-creating the random list shown in FIG. 5.

FIG. 9 is an illustrative view showing one example of a memory map of the SDRAM shown in FIG. 1.

FIG. 10 is a flowchart showing display processing by a processor shown in FIG. 1.

FIG. 11 is a flowchart showing a part of image switch controlling processing by the processor shown in FIG. 1.

FIG. 12 is a flowchart showing another part of the image switch controlling processing by the processor shown in FIG. 1, and sequel to FIG. 11.

FIG. 13 is a flowchart showing first time random list creating processing by the processor shown in FIG. 1.

FIG. 14 is a flowchart showing next time random list creating processing by the processor shown in FIG. 1.

FIG. 15 is a flowchart showing image expanding processing by the processor in FIG. 1.

### FORMS FOR EMBODYING THE INVENTION

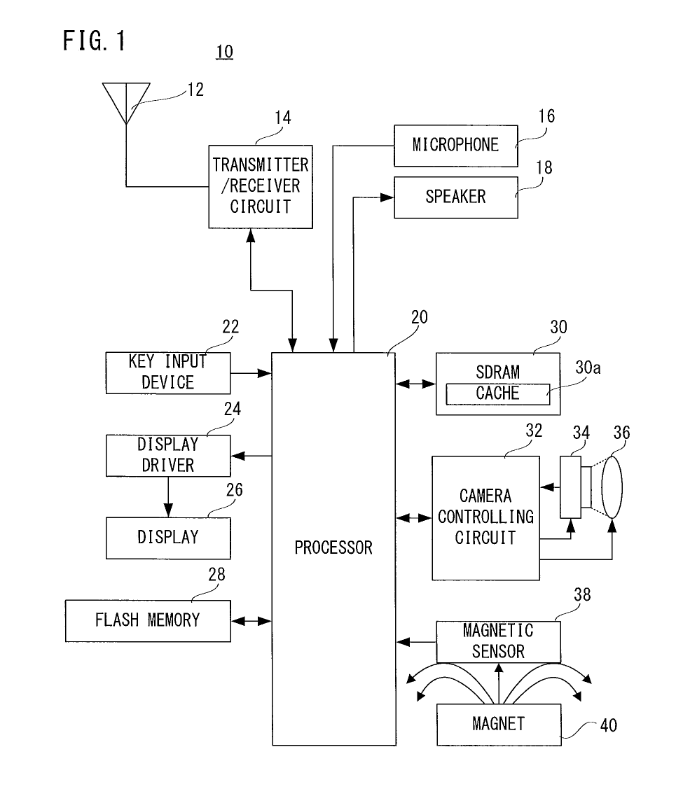

Referring to FIG. 1, a mobile terminal 10 includes a processor 20, a key input device 22, etc. The processor 20, which may be called a CPU or a computer, controls a transmitter/receiver circuit 14 compatible with a CDMA system to output a incoming call signal. The output incoming call signal is issued from an antenna 12 and sent to mobile communication networks including base stations. When a communication partner performs an off-hook operation, a speech communication possible state is established.

When a speech communication end operation is performed by the key input device 22 after a shift to the speech communication possible state, the processor 20 sends a speech communication end signal to a communication partner by controlling the transmitter/receiver circuit 14. Then, after sending the speech communication end signal, the processor 20 ends the speech communication processing. Furthermore, in a case that a speech communication end signal is first received from the communication partner as well, the processor 20 ends the speech communication processing. In addition, in a case that a speech communication end signal is received from the mobile communication network independent of the communication partner as well, the processor 20 ends the speech communication processing.

When an incoming call signal from the communication partner is received by the antenna 12 in a state the mobile phone apparatus 10 is started up, the transmitter/receiver circuit 14 notifies the processor 20 of an incoming call. The processor 20 may vibrate the mobile phone apparatus 10 by driving a vibrator not shown, and notify a user of the incoming call. Here, the processor 20 vibrates the mobile terminal 10, and outputs a ringing tone from a speaker not shown.

In the speech communication possible state, following processing is executed. A modulated audio signal sent from the communication partner is received by the antenna 12. The received modulated audio signal is subjected to demodulation processing and decoding processing by the transmitter/receiver circuit 14. Then, the received voice signal that is obtained is output from a speaker 18. On the other hand, a voice signal to be transmitted that is captured by a microphone 16 is subjected to encoding processing and modulation processing by the transmitter/receiver circuit 14. Then, the generated modulated audio signal is sent to the communication partner by means of the antenna 12 as in the above description.

Here, the antenna 12 and the transmitter/receiver circuit 14 that receive the incoming call signal and the calling source information function as a receiver. Furthermore, a main display 26 may be called a displayer or a display device.

Moreover, the mobile terminal 10 of this embodiment can execute a camera function. For example, when an operation of executing the camera function is performed on the key input device 22, a camera controlling circuit 32 and an image sensor 34 are worked as an imager to thereby execute the camera function.

For example, an optical image of an object scene is irradiated onto an imaging area of the image sensor 34. On the imaging area of the image sensor 34, charge-coupled devices corresponding to the SXGA (1280×1024 pixels) are arranged. On the imaging area, a raw image signal of SXGA, that is, electric charges corresponding to the optical image of the object scene is generated by photoelectronic conversion. Here, the user can change the size of the image data to the XGA (1024×768 pixels), the Full-WVGA (854×480 pixels), etc. other than the SXGA.

Then, when the camera function is executed, the processor 20 starts up an image sensor driver contained in the camera controlling circuit 32 to instruct it to perform an exposure operation and an electric charge reading operation corresponding to the designated reading area in order to display a real-time motion image of the object scene, that is, a through-image on the display 26.

The image sensor driver performs an exposure of the imaging surface of the image sensor 34 and reading of electric charges generated by the exposure. Consequently, a raw image signal is output from the image sensor 34. Furthermore, the output raw image signal is input to the camera controlling circuit 32, and the camera controlling circuit 32 performs processing, such as color separation, white balance adjustment, YUV conversion, etc. on the input raw image signal to thereby generate image data in a YUV format. Then, the image data in a YUV format is input to the processor 20. At this time, the camera controlling circuit 32 controls a focus lens 36 to bring object scene into focus.

Furthermore, the image data in the YUV format input to the processor 20 is temporarily stored in an SDRAM 30 by the processor 20. In addition, the stored image data in the YUV format is applied to a display driver 24 from the SDRAM 30 via the processor 20. At the same time, the processor 20 issues a thinning-out reading instruction to the display driver 24. Then, the display driver 24 outputs the image data in the YUV format to the display 26 at 30 fps in response to the thinning-out reading instruction issued by the processor 20. Thus, a low-resolution (320×240 pixels, for example) through-image representing the object scene is displayed on the display 26.

Here, in the image data of the YUV format, Y means luminance, U means a color difference obtained by subtracting the luminance from blue, and V means a color difference obtained by subtracting the luminance from red. That is, the image data of the YUV format is made up of luminance signal (Y) data, blue color-difference signal (U) data, and red color-difference signal (V) data.

Here, when an imaging operation is performed by the key input device 22, the processor 20 executes main imaging processing. That is, the processor 20 performs compression according to a JPEG format on the raw image signal of SXGA output from the image sensor 34, and temporarily stores the converted image data in the SDRAM 30. Also, the processor 20 reads the image data in the JPEG format that is temporarily stored, and records an image file including the read image data in a NAND type flash memory 28 (first memory). Then, the processor 20 causes a speaker not shown to output sound for notifying that the main imaging processing is being executed. Here, in the flash memory 28, a plurality of folders are provided, and the imaged image data is stored in a predetermined folder.

Furthermore, when the stored image data is displayed on the display 26, list data (list database: may be called a “RDB”) of the folder in which the designated image data is stored is first acquired by the processor 20. The processor 20 reads the image data from the flash memory 28 on the basis of the acquired list data, and temporarily stores it in the SDRAM 30. Also, the processor 20 decodes (expands) the image data stored in the SDRAM 30 into display data having RGB information. Then, the expanded display data is stored in a cache 30a (second memory) included in the SDRAM 30, and whereby, an image corresponding to the display data stored in the cache 30a is displayed on the display 26.

It should be noted that in this embodiment, the time required to display the image data stored in the flash memory 28 is about one to three seconds being made up of a time before the list data is acquired, a time before the image data is read and a time before the read image data is decoded.

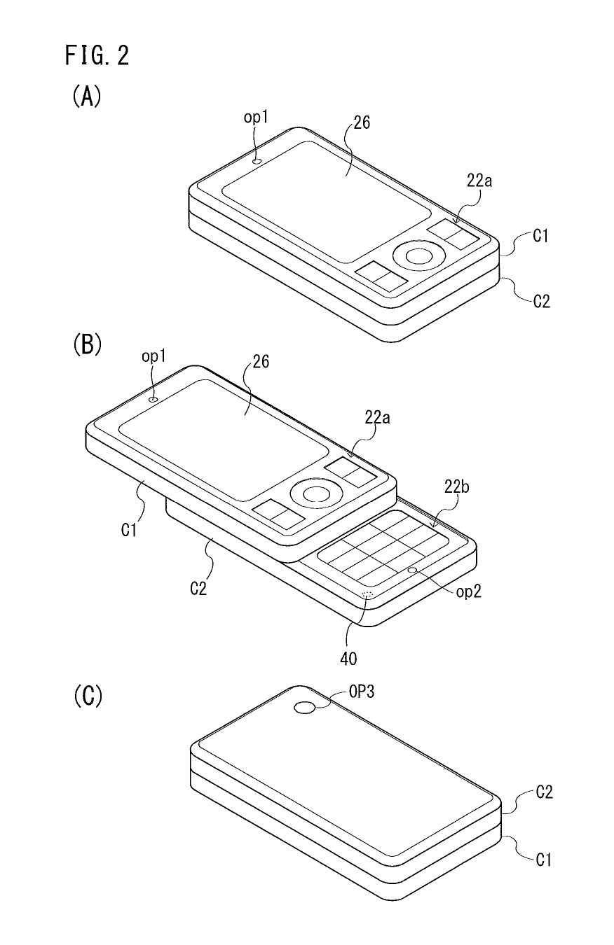

FIG. 2 (A) is an illustrative view showing an appearance of the slidable mobile terminal 10 in a closed position, FIG. 2 (B) is an illustrative view showing an appearance of the slidable mobile terminal 10 in an open position, and FIG. 2 (C) is an illustrative view showing the underside of the slidable mobile terminal in the closed position. With reference to FIG. 2 (A) to FIG. 2(C), the mobile terminal 10 has a first case C1 and a second case C2 each being configured in the form of plate, and the first case C1 and the second case C2 are approximately the same in thickness.

The first case C1 is coupled with the second case C2 by means of a sliding mechanism not shown so as to be stacked (piled) on the second case C2. Accordingly, as shown in FIG. 2 (B), the first case C1 can be slid in a longitudinal direction of the second case C2.

The microphone 16 not shown is contained in the second case C2, and an opening OP2 communicating with the contained microphone 16 is provided at one end of the top surface in the longitudinal direction of the second case C2. Similarly, the speaker 18 not shown is contained in the first case C1, and an opening OP1 communicating with the contained speaker 18 is provided at the one end of the top surface in the longitudinal direction of the first case C1.

The key input device 22 includes a first keypad 22a and a second keypad 22b each including a plurality of keys. The first keypad 22a is made up of a direction key, an off-hook key, an on-hook key, a menu key and a decide key, and is provided on the top surface of the first case C1. Also, the second keypad 22b is made up of a numeric keypad, etc., and provided on the top surface of the second case C2. Furthermore, the display 26 is provided such that the monitor screen is exposed from the top surface of the first case C1.

For example, the user can input a phone number by operating the numeric keys of 0 to 9, perform an incoming call operation by the off-hook key, and perform an speech communication end operation by the on-hook key while viewing the display 26. Furthermore, the user can display a menu screen by operating the menu key, and select an arbitrary menu by the direction key, etc. In addition, the user can decide a selected menu by operating the decide key. Then, the user can switch the power of the mobile terminal 10 between ON and OFF by holding the on-hook key on.

Also, on the underside of the second case C2, an opening OP3 that communicates with the image sensor 34 and the focus lens 36 is further provided. For example, by directing the underside of the second case C2 to an object, the user can image the object.

A magnetic sensor 38 is contained in the other end of the first case C1 in the longitudinal direction, and a magnet 40 is contained in the one end of the second case C2 in the longitudinal direction so as to be the closest state with the first magnetic sensor 38 in the state shown in FIG. 2 (A). Then, the magnetic sensor 38 for detecting the opening and closing positions of the mobile terminal 10 outputs a maximum value in the state shown in FIG. 2 (A), and outputs a minimum value in the state shown in FIG. 2 (B).

Here, the antenna 12, the transmitter/receiver circuit 14, the processor 20, the display driver 24, the flash memory 28 and the SDRAM 30 are contained in the first case C1 or the second case C2, and are not shown in FIG. 2 (A) to FIG. 2(C). Furthermore, the magnetic sensor 38 and the magnet 40 may be called a detector. In addition, the detector may not be restricted to usage of the magnetic sensor 38 and the magnet 40, and may be a detecting mechanism in which in response to the opening and closing positions, a depressing portion provided to one case mechanically pushes a depressed portion of the other case to thereby detect a change of the energized state due to the pushed state, whereby the opening and closing of the mobile terminal may be detected, as another example.

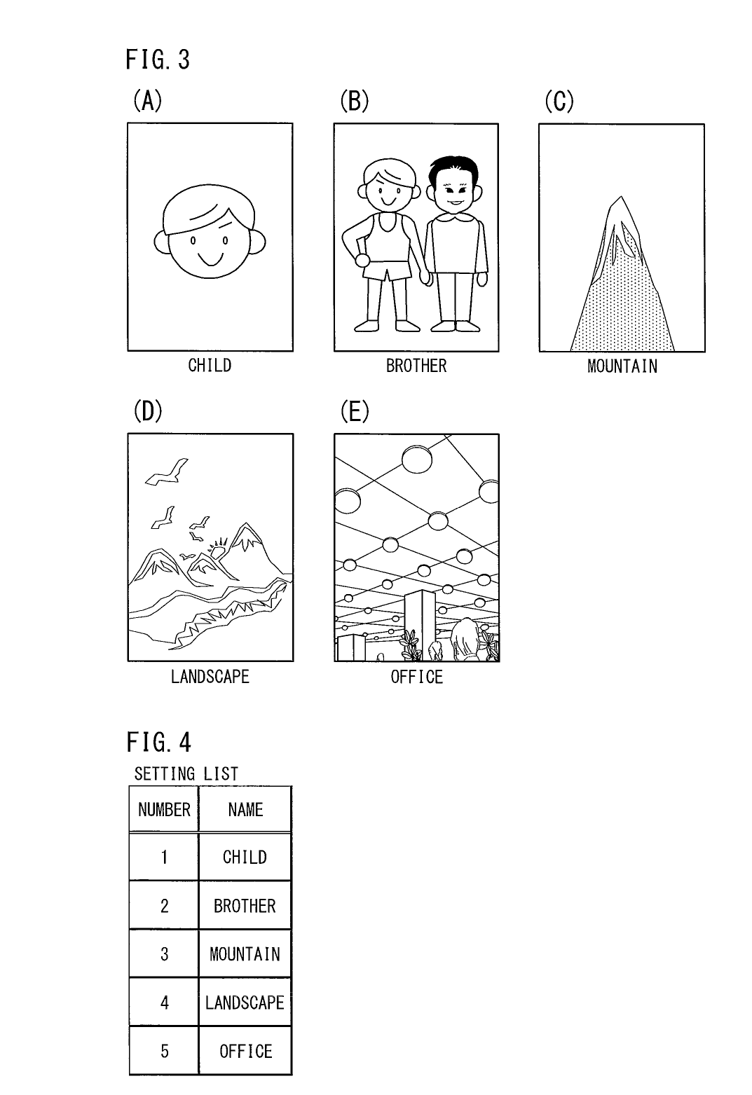

FIG. 3(A) to FIG. 3(E) is an illustrative view showing one example of image data stored in the flash memory 28. To the image data shown in FIG. 3(A), FIG. 3(B), FIG. 3(C), FIG. 3(D) and FIG. 3(E), “child”, “brother”, “mountain”, “landscape” and “office” are respectively set as a data name. For example, each of the image data shown in FIG. 3(A) to 3(E) is imaged by using the camera function, and each image data is stored in a folder set to the flash memory 28.

Here, as to the data name immediately after imaging, arithmetic progression indicating an imaging date and time “090902_{—}1450 (indicating Sep. 2, 2009, 14:50)” is automatically set. Then, character strings, such as hiragana characters, katakana characters, kanji characters, etc. in the data name are set by the user.

The mobile terminal 10 of the present embodiment has an image switching function of switching an image to be displayed on the display 26 every time that the mobile terminal 10 is in the open position. For example, when the user selects an arbitrary folder and performs a predetermined operation, the image switching function is executed. During execution of the image switching function, the plurality of sets of image data stored in the selected folder (hereinafter, referred to as “setting folder”) are expanded as a plurality of sets of display data, and are stored in a cache 30a provided to the SDRAM 30. Then, the processor 20 displays an image corresponding to the display data on the display 26, and switches it to another display data in response to a detection of the open position, to thereby switch the image displayed on the display 26. Here, the time from when the display data is switched to when another image is displayed is about 100 ms.

Thus, the user can quickly change the image displayed on the display 26 by merely shifting the mobile terminal 10 to the open position. Here, when the size of the image data is large, it takes a time before it is expanded, and thus, in a case that a switch is made to an image based on the image data of a large size, the present invention is especially effective.

FIG. 4 is an illustrative view showing list data of the folder in which the image data shown in FIG. 3(A) to FIG. 3(E) is stored. In this embodiment, images are switched on the basis of each image data shown in FIG. 3(A) to FIG. 3(E) in order and thus, the list is called a “setting list”.

With reference to FIG. 4, the setting list is composed of columns of “number” and “name”. In the column of the “number”, a number corresponding to the image data is recorded in order. Furthermore, in the column of the “name”, a data name of the image data is recorded, and a data name “child” of the image data shown in FIG. 3(A), for example, is recorded. Here, the “number” is decided on the basis of an imaging date and time, a name of image data (data name), etc.

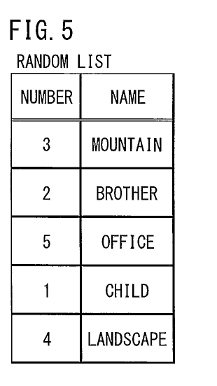

FIG. 5 is an illustrative view showing a list representing an order of switching the images. In this embodiment, here, the order of the images is randomly changed, and therefore, the list shown in FIG. 5 is called “random list”.

With reference to FIG. 5, the random list is composed of columns of “number” and “name” similar to the setting list. Also, numbers recorded in the column of “number” do not have their rules, but each of the image data in the folder is arranged so as to be sure to be displayed once. For example, when the random list is created, if a maximum value of the setting list, that is, the number of image data is 5, an arithmetic progression where numbers from 1 to 5 are re-arranged such that each number is sure to be used once, and the same number is not used again. Then, on the basis of the created arithmetic progression, the column of “number” on the random list is set.

Then, the image to be displayed on the display 26 is switched on the basis of the column of “number” on the random list. For example, if the numbers “3, 2, 5, 1, and 4” are recorded in this order from the top of the cells in the column of “number”, the order of switching the images is “mountain, brother, office, child, and landscape”.

Thus, by deciding in advance the order of switching the images, image switching processing can be further increased in speed.

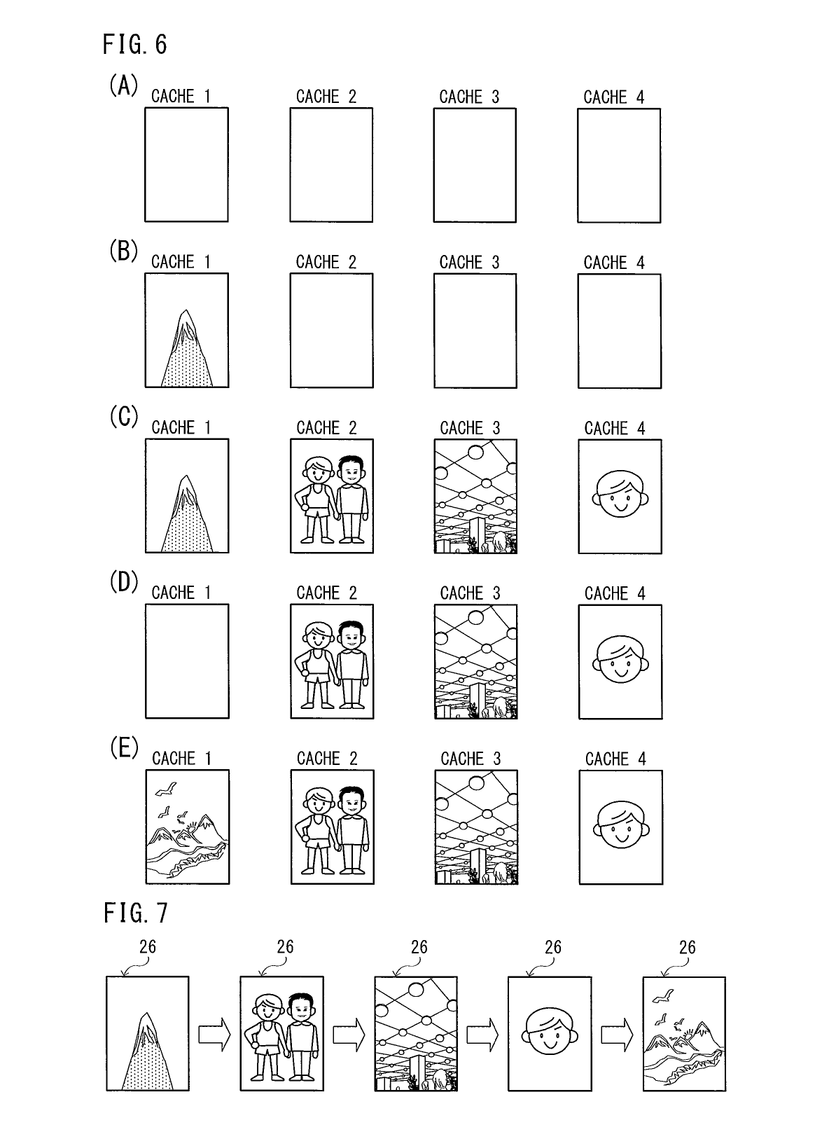

FIG. 6(A) to FIG. 6(E) is an illustrative view showing a state in which display data is expanded in the cache 30a. Here, the drawing of the display data expanded in the cache 30a and the drawing of the image data shown in FIG. 3(A) to FIG. 3(E) are the same for the sake of simple explanation, but are different in terms of data.

With reference to FIG. 6(A), in the cache 30a, four cache areas are set in order to store four sets of display data. Here, each cache area is called a cache 1, a cache 2, a cache 3, and a cache 4. Then, the caches 1 to 4 in FIG. 6(A) show a state that no data is stored. It should be noted that this state of the cache 30a is when the power of the mobile terminal 10 is turned on, or a setting of the image switching function is changed.

Next, with reference to FIG. 6(B), the processor 20 reads image data from the flash memory 28, and stores the expanded display data in the cache 1. For example, when the image data having the data name of “mountain” is read from the flash memory 28 and is expanded, the expanded display data is stored in the cache 1. Furthermore, when the display data is expanded in the cache 1, the processor 20 displays the image on the display 26. That is, the photograph of the mountain is displayed on the display 26. Here, at this time, another display data is not expanded, and thus, no data is stored in the caches 2 to 4.

Next, with reference to FIG. 6(C), the processor 20 further reads image data from the flash memory 28, and stores each display data in the cache 2, the cache 3 and the cache 4. That is, image data each having the data name of “brother”, “office” and “child” is read from the flash memory 28 based on the random list, and each display data obtained by expanding the image data is stored in the cache 2, the cache 3 and the cache 4.

Next, when the mobile terminal 10 is in the open position, the image that is being displayed on the display 26 is switched from the display data stored in the cache 1 to the display data stored in the cache 2. Then, with reference to FIG. 6(D), when switching the image, the processor 20 deletes the display data stored in the cache 1. That is, the cache 1 is in a state of storing no data.

Next, when deleting the image data stored in the cache 30a, the processor 20 reads new image data from the flash memory 28 and expands the image data. Then, with reference to FIG. 6(E), the processor 20 stores the display data that is newly expanded in the cache 1.

Thus, in this embodiment, the display data corresponding to the image that has already been displayed is deleted from the cache 30a, and new display data is expanded in the cache 30a. Accordingly, it is possible to switch a plurality of images by utilizing the cache 30a having low data capacity.

FIG. 7 is an illustrative view showing a state in which the image which is being displayed on the display 26 is switched. With reference to FIG. 7, the image of “mountain” is first displayed on the display 26 on the basis of the random list (see FIG. 5). When the mobile terminal 10 is shifted to the open position in this state, the image of the display 26 is switched to the image of “brother”. Then, every time that the mobile terminal 10 is shifted to the open position, the image is switched from “office”, “child” to “landscape” in this order.

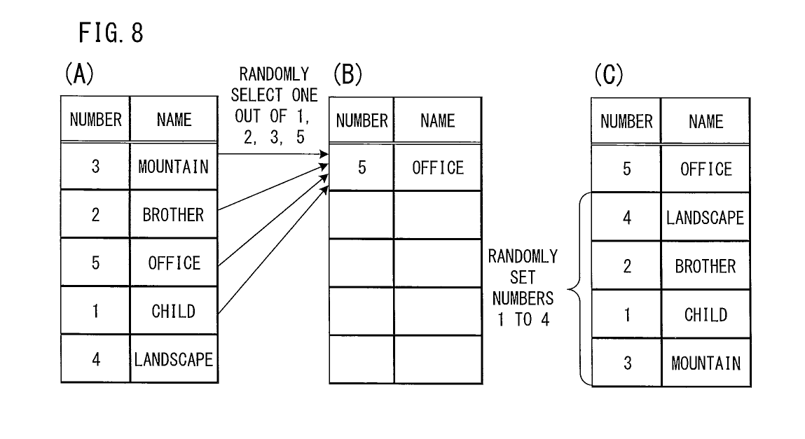

Here, when all the images are displayed on the basis of the random list that is created at the first time, a random list is created again. With reference to FIG. 8(A) and FIG. 8(B), when the random list is created again, in addition to the creation condition of the random list that is created at the first time, the last number on the previous random list is set so as not to be the same as the first number on the current random list. That is, the same image is never displayed successively.

For example, if the last number on the previous random list is “4”, the first number on the current random list is a number randomly selected from numbers 1, 2, 3, 5.

Next, if the first number is “5”, the numbers other than “5”, that is, the numbers 1 to 4 are rearranged similar to the random list at the first time. For example, with reference to FIG. 8(A) and FIG. 8(C), if the column of “number” on the previous random list is “3, 2, 5, 1, 4”, the column of “number” on the current random list is “5, 4, 2, 1, 3”.

Thus, it is possible to switch the images in the random order without the same image being displayed successively.

Here, in a case that the image data is randomly updated by an image updating function, this may be called not “image updating function” but “open shuffle”. Also, the image switching order may be an order according to the numbers on the setting list, or may be an order decided by the user.

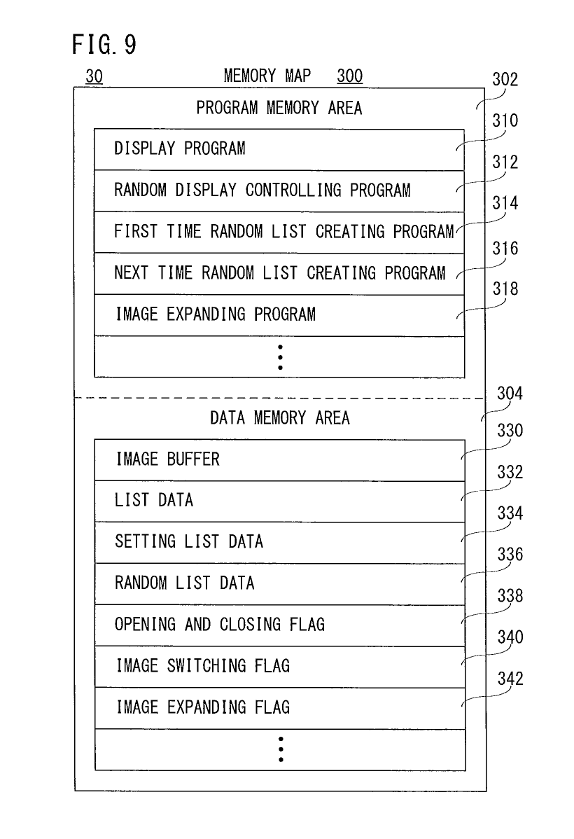

FIG. 9 is an illustrative view showing a memory map 300 of the SDRAM 30. Referring to FIG. 9, in the memory map of the SDRAM 30, a program memory area 302 and a data memory area 304 are included. A part of programs and data are read entirely at a time, or partially and sequentially as necessary from the flash memory 28, stored in the SDRAM 30, and then executed by the CPU 20, etc.

In the program memory area 302, a program for operating the mobile terminal 10 is stored. The program for operating the mobile terminal 10 is made up of a display program 310, an image switch controlling program 312, a first time random list creating program 314, a next time random list creating program 316, an image expanding program 318, etc.

The display program 310 is a program for executing entire processing to display an image on the display 26. The image switch controlling program 312 is a program for switching images displayed on the display 26 in a random order. The first time random list creating program 314 is a program for creating a random list, and is executed immediately after the power of the mobile terminal 10 is turned on or immediately after the image switching function is executed. The next time random list creating program 316 is a program for creating a random list similar to the first time random list creating program 314, but is executed for creating the random list to be used at the next time (second time) onward.

The image expanding program 318 is a program for expanding image data, and storing the display data in the cache 30a, and is executed at all times if the random list is created, and further display data can be stored in the cache 30a.

Although illustration is omitted, the program for operating the mobile terminal 10 includes a program for speech communications.

In the data memory area 304, image buffer 330, etc. is provided, and list data 332, setting list data 334, random list data 336, etc. are stored. Furthermore, in the data memory area 304, an opening and closing flag 338, an image switching flag 340, an image expanding flag 342, etc. are provided.

The image buffer 330 is a buffer for temporarily storing the image data read from the flash memory 28. The list data 332 is data of a list corresponding to a folder provided in the flash memory 28. Also, the list data 332 is made up of a plurality of list data in a case that a plurality of folders are set.

The setting list data 334 is data of the setting list shown in FIG. 4, for example, and data of a list corresponding to the folder selected by the user. The random list data 336 is data of the random list shown in FIG. 5, for example, and represents the order in which images are switched.

The opening and closing flag 338 is a flag for detecting the open position and the closed position of the mobile terminal 10. For example, the opening and closing flag 338 is formed of a one-bit register. When the opening and closing flag 338 is turned on (established), a data value “1” is set to the register. On the other hand, when the opening and closing flag 338 is turned off (not established), a data value “0” is set to the register. Furthermore, if the opening and closing flag 338 is turned on, the open position is indicated, and if it is turned off, the closed position is indicated. Also, the opening and closing flag 338 is switched between the ON state and the OFF state depending on the value output from the magnetic sensor 32.

The image switching flag 340 is a flag for determining whether or not the image switching function is set so as to be executed. The image expanding flag 342 is a flag for determining whether or not expansion of the display data is completed.

Here, the configuration of the image switching flag 340 and the image expanding flag 342 is the same as that of the opening and closing flag 338, and therefore, a detailed description thereof is omitted. Also, in the memory map 300 shown in FIG. 9, the illustration of the cache 30a is omitted. In addition, although illustration is omitted, in the data memory area 304, ringing tone data, etc. is stored, and counters and flags necessary for operating the mobile terminal 10 are also provided.

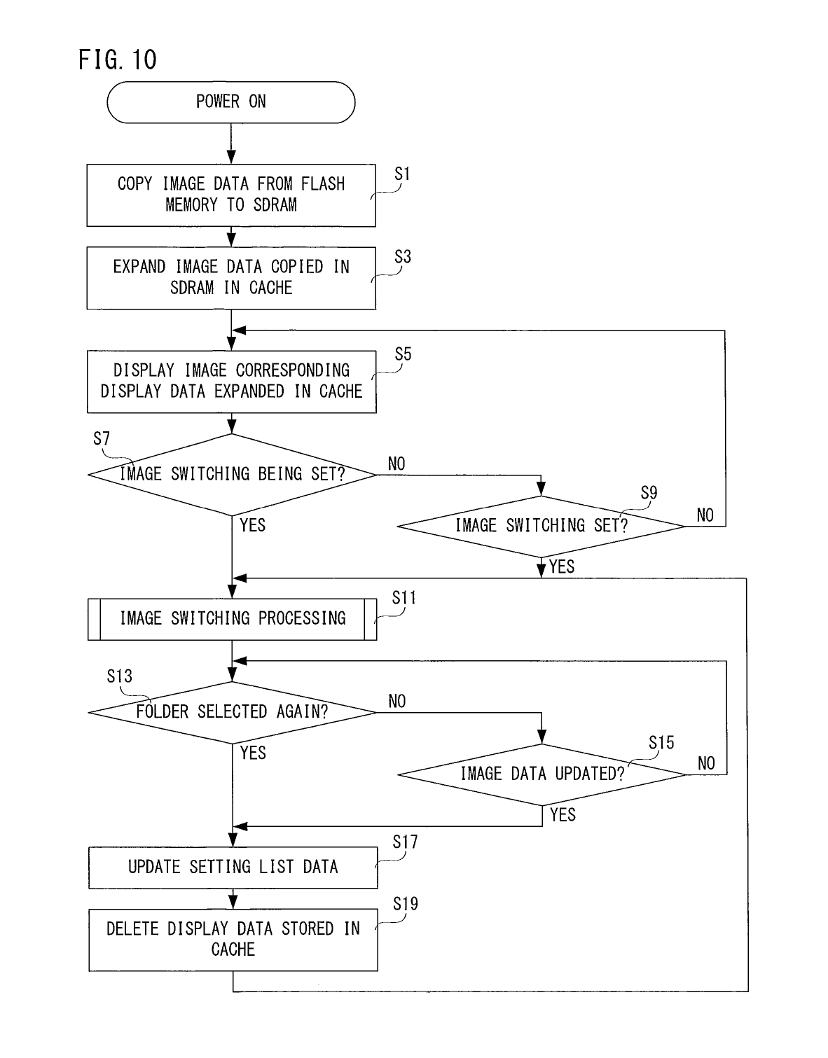

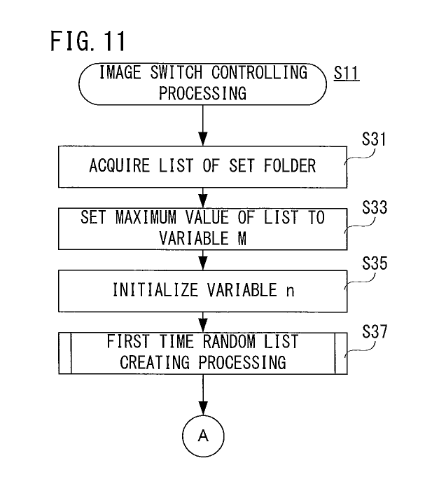

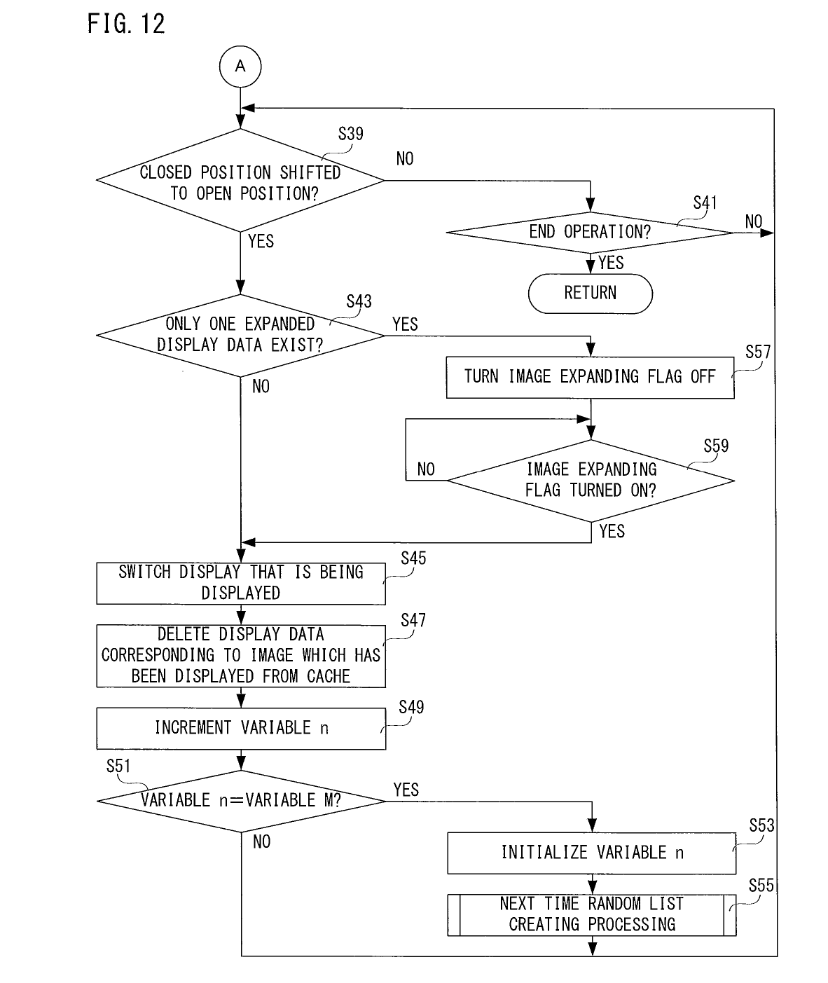

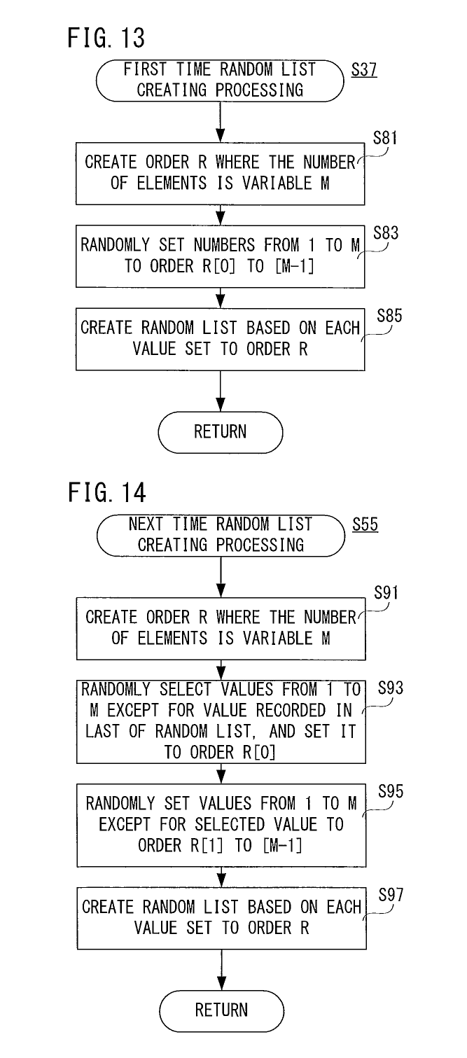

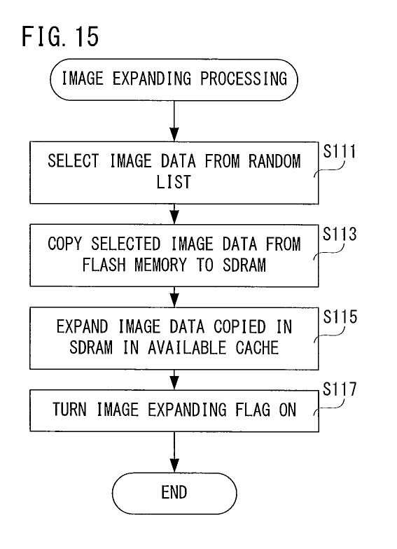

The processor 20 executes a plurality of tasks in parallel including display processing shown in FIG. 10, image switch controlling processing shown in FIG. 11 and FIG. 12, first time random list creating processing shown in FIG. 13, next time random list creating processing shown in FIG. 14, image expanding processing shown in FIG. 15, etc. under the control of RTOS (Real-time Operating System), such as “Linux (registered trademark)”, “REX”, etc.

FIG. 10 is a flowchart showing display processing. When the power of the mobile terminal 10 is turned on, the processor 20 copies image data from flash memory 28 to the SDRAM 30 in a step S1. That is, the image data stored in the flash memory 28 is read, and stored in the image buffer 330.

It should be noted that the image data read here is image data displayed in the standby condition. Furthermore, in a case that the power is turned on with the image switching function executed, that is, in a case of restarting, image data corresponding to the image displayed last may be read from the flash memory 28.

Succeedingly, in a step S3, the image data copied in the SDRAM 30 is expanded in the cache 30a. That is, the processor 20 expands the image data stored in the image buffer 330 to the display data, and stores the display data in the cache 30a. Then, in a step S5, an image corresponding to the display data expanded in the cache 30a is displayed on the display 26. For example, in a case that the image data representing the standby condition is read from the flash memory 28, an image representing the standby condition is displayed on the display 26.

Succeedingly, in a step S7, it is determined whether or not image switching is being set. That is, it is determined whether or not the image switching flag 340 is turned on. If “YES” in the step S7, that is, if the image switching function is set so as to be executed, the process proceeds to a step S11. On the other hand, if “NO” in the step S7, that is, if the image switching function is set so as not to be executed, it is determined whether or not an image switching is set in a step S9. For example, it is determined whether or not the image switching function is set so as to be executed by the user. If “NO” in the step S9, that is, if the image switching function is not set to be executed, the process returns to the step S5. On the other hand, if “YES” in the step S9, that is, if the image switching function is set to be executed, the image switch controlling processing is executed in a step S11. It should be noted that the image switch controlling processing is described later by using the flowcharts shown in FIG. 11 and FIG. 12, and thus, detailed description is omitted here.

After completion of the image switch controlling processing, in a step S13, it is determined whether or not the folder is selected again. For example, it is determined whether or not the setting folder is selected again by the user. If “YES” in the step S13, that is, if the folder is selected again, the process proceeds to a step S17. On the other hand, if “NO” in the step S13, that is, if the folder is not selected again, it is determined whether or not the image data is updated in a step S15. For example, it is determined whether or not the image data stored in the set folder is deleted, or image data is added to this folder. If “NO” in the step S15, that is, if the image data is not updated, the process returns to the step S13. On the other hand, if “YES” in the step S15, that is, if the image data is updated, the process proceeds to the step S17.

In the step S17, the setting list data 334 is updated. That is, if the folder is selected again, the list data of the folder that is selected again is acquired to update the setting list data 334. Also, if the image data is updated, the list data of the folder that is being currently set is acquired again, and the setting list data 334 is updated. Succeedingly, in a step S19, the display data stored in the cache 30a is deleted, and the process returns to the step S11. That is, when the folder or the image data is changed, the display data stored in the cache 30a is deleted. Then, when the display data stored in the cache 32a is deleted, the process returns to the step S11 to execute the image switch controlling processing again.

Thus, the display data stored in the cache 30a is deleted in response to selection of the folder again, and a switch of the image data, and therefore, a change can be performed on the setting folder. Here, the processor 20 executing the processing in the step S19 functions as a deleter.

FIG. 11 is a flowchart showing the image switch controlling processing executed in the step S5 (see FIG. 10). The processor 20 acquires a list of the set folder in a step S31. That is, the processor 20 reads the setting list data 334 from the SDRAM 30. Succeedingly, in a step S33, the maximum value of the list is set to the variable M.

That is, the maximum number stored in the column of “number” on the setting list is set to the variable M. For example, in a case that the setting list shown in FIG. 4 is read, “5” is set to the variable M.

Succeedingly, in a step S35, the variable n is initialized. The variable n is a variable for counting the number of times that an image is switched. Here, “1” is set to the variable n at a time of the initialization. Then, in a step S37, the first time random list creating processing is executed, and the process proceeds to a step S39 shown in FIG. 12. It should be noted that the first time random list creating processing is described later by using the flowchart shown in FIG. 13, and thus, a detailed description thereof is omitted here.

Succeedingly, in the step S39, it is determined whether or not the closed position is shifted to the open position. That is, it is determined whether or not the opening and closing flag 338 is turned on. If “YES” in the step S39, that is, if the opening and closing flag 338 is turned on, the process proceeds to a step S43. On the other hand, if “NO” in the step S39, that is, if the opening and closing flag 338 is not turned on, it is determined whether or not an end operation is performed in a step S41. For example, it is determined whether or not an operation of selecting again the set folder or an operation of updating image data is performed. If “NO” in the step S41, that is, if the end operation is not performed, the process returns to the step S39. On the other hand, if “YES” in the step S41, that is, if the end operation is performed, the image switch controlling processing is ended, and the process returns to the display processing (see FIG. 10).

Furthermore, when the mobile terminal 10 is shifted to the open position, it is determined whether or not only one expanded display data exists in the step S43. That is, it is determined whether or not display data corresponding to the image that is being currently displayed is stored in the cache 30a. If “YES” in the step S43, that is, if only one extended display data exists, the process proceeds to a step S57. On the other hand, if “NO” in the step S43, that is, if a plurality of sets of display data are expanded, the image that is being displayed is switched in a step S45. For example, if the image corresponding to the display data stored in the cache 1 is being displayed, the processor 20 switches it to the display data stored in the cache 2 to thereby switch the image. Here, the processor 20 executing the processing in the step S45 functions as a switching displayer.

Succeedingly, in a step S47, the display data corresponding to the image which has been displayed is deleted from the cache 30a. For example, in a case that the image was displayed on the basis of the display data stored in the cache 1, the display data stored in the cache 1 is deleted. Here, the processor 20 executing the processing in the step S47 functions as a deleter. Then, in a step S49, the variable n is incremented. That is, the displaying image is switched to thereby increment the value set to the variable n.

Then, in a step S51, it is determined whether or not the variable n is equal to the variable M. That is, it is determined whether or not switching to the last image on the random list is made. If “NO” in the step S51, that is, if a switch to the last image is not made, the process returns to the step S39. On the other hand, if “YES” in the step S51, that is, if a switch to the last image is made, the variable n is initialized in a step S53. That is, the variable n is initialized in order to create the random list again. Succeedingly, in a step S55, next time random list creating processing is executed, and the process returns to the step S39. Here, the next time random list creating processing is described later by using the flowchart shown in FIG. 14, and thus, the description in detail is omitted.

It should be noted that the next time random list creating processing in the step S55 is not restricted to the processing to be performed when a switch to the last image on the random list is made as shown in FIG. 12. For example, the random list creating processing may be performed at an approximate timing, such as when the image displayed first is switched, when the variable n is less than the variable M by a predetermined value (“M−3”, etc. for example), or the like.

Here, if the mobile terminal 10 is shifted to the open position with only the display data of the image which is currently being displayed stored, the image expanding flag 342 is turned off in the step S57. That is, in order to wait for the end of the processing of expanding the image data, the image expanding flag 342 is turned off. Succeedingly, in a step S59, it is determined whether or not the image expanding flag 342 is turned on. That is, it is determined whether or not the processing of expanding new image data in the cache 30a is ended. If “NO” in the step S59, that is, if the processing of expanding image data is not ended, the processing in the step S59 is repeatedly executed. On the other hand, if “YES” in the step S59, that is, if the processing of expanding image data is ended, the process proceeds to the step S45. That is, the image displayed on the display 26 is switched.

It should be noted that in the image switch controlling processing, execution of the processing in the steps S43, S57, S59 can prevent the following problems from occurring. In this embodiment, the processing of expanding the image data in the cache 30a is executed faster than the processing of deleting the display data stored in the cache 30a. Thus, if the user repetitively opens and closes the mobile terminal 10, the display data for switching the display may not be stored even when the mobile terminal 10 is shifted to the open position. At this time, when all the image switching instructions are stored, every time that the display data is expanded, the image is switched again and again. That is, the image is switched again and again at a timing that the user never intends, and therefore, the user may feel anxiety about the operation of the mobile terminal 10. However, in this embodiment, even if the image data is expanded one after another, the image is switched once, and thus, the problem as described never occurs.

Furthermore, if the image data stored in the folder is changed, the next time random list creating processing is executed in place of the first time random list creating processing in the step S37. Thus, when the image data stored in the setting folder is changed as well, the random list is created so as not to display the same image successively.

FIG. 13 is a flowchart showing the first time random list creating processing executed in the step S37 (see FIG. 11). The processor 20 creates an array R where the number of elements is the variable M in a step S81. That is, in the step S81, the array R is created by bringing it into correspondence with the setting list. For example, if the variable M is 5, the array R[0] to [4(=5-1)] is created.

Succeedingly, in a step S83, numbers from 1 to M are randomly set to the array R[0] to [R−1]. That is, in the step S83, random numbers are generated from only the values 1 to M, and arithmetic progression where each of the numbers from 1 to M is sure to be used once is created. Then, each number of the produced arithmetic progression is set from the array R[0] to [M−1]. For example, if the variable M is 5, 3 is set to the array R[0], 2 is set to the array R[1], 5 is set to the array R[2], 1 is set to the array R[3], and 4 is set to the array R[4].

Then, in a step S85, a random list is created on the basis of the respective numbers set to the array R, and the process returns to the image switch controlling processing. For example, in the step S85, as shown in the random list in FIG. 5, in the column of “number”, numbers of the array R[0] to R[4] are set. In the column of the “name”, the data name corresponding to the column of “number” is recorded on the basis of the setting list shown in FIG. 4.

FIG. 14 is a flowchart showing the next time random list creating processing executed in the step S55 (see FIG. 14). Here, the processing in steps S91 and S97 is the same as that in the step S81 and step the S85, and therefore, the detailed description thereof is omitted.

The processor 20 creates the array R where the number of elements is the variable M in the step S91. Successively, in a step S93, one of the numbers from 1 to M except for the number recorded in the last of the random list is randomly selected, and set to the array R[0]. For example, with reference to FIG. 8(A), if the number recorded in the last of the previous random list is “4”, and the variable M is 5, one value from the numbers 1 to 5 is first selected on the basis of the time random number processing. Next, if the selected value is not “4”, the selected value is set to the array R[0].

Successively, in a step S95, the values of 1 to M except for the selected value are randomly set to the array R[1] to [R−1]. That is, in the processing of the step S95, similar to the processing in the step S83, arithmetic progression where each of the numbers from 1 to M except for the selected number is sure to be used once is created, and each value in the arithmetic progression is set to the array R[1] to [M−1]. For example, with reference to FIG. 8(C), if the selected value is “5”, and the variable M is 5, 4 is set to the array R[1], 2 is set to the array R[2], 1 is set to the array R[3], and 3 is set to the array R[4].

Succeedingly, in the step S97, a random list is created on the basis of the respective values set to the array R, and the process returns to the image switch controlling processing. That is, in the step S97, the random list to be used in the second time onward is created.

Here, in the “random numbers” generated in the present embodiment, “random numbers” in which the same numbers are successively generated are not included. Furthermore, the processor 20 executing the processing in the steps S83, S93, S95 functions as a setter, and the processor 20 executing the processing in the steps S85, S97 functions as a creator. Also, the processor 20 executing the processing in the steps S93, S95 functions as a resetter, the processor 20 executing the processing in the step S93 functions as a first setter, and the processor 20 executing the processing in the step S95 functions as a second setter.

FIG. 15 is a flowchart showing the image expanding processing. For example, when the cache 30a is able to store the display data, and the random list is created, the processor 20 selects the image data from the random list in a step S111. That is, one of the image data stored in the flash memory 28 is selected on the basis of the random list.

Succeedingly, in a step S113, the selected image data is copied from the flash memory 28 to the SDRAM 30. That is, the image data selected based on the random list is read from the flash memory 28, and the image data is stored in the image buffer 330. Then, in a step S115, the image data copied in the SDRAM 30 is expanded in an available cache. For example, out of the caches 1-4 shown in FIG. 6(A), etc., the expanded display data is stored in the cache in which the display data is not stored, that is, the available cache. Here, the processor 20 executing the processing in the step S115 functions as an expander.

Succeedingly, in a step S117, the image expanding flag 342 is turned on, and the image expanding processing is ended. That is, expanding of the image data is ended, and therefore, the image expanding flag 342 is turned on.

As can be understood from the above description, the mobile terminal 10 has the flash memory 28 for storing image data and the display 26 for displaying an image based on the image data. Furthermore, if in the mobile terminal 10, the image switching function is executed, the image which is being displayed on the display 26 is randomly switched on the basis of the random list. The processor 20 creates the random list in which each of the plurality of images stored in the setting folder is sure to be selected once.

Thus, each of the plurality of image data is sure to be selected once and displayed, and therefore, it is possible to randomly switch the images and make the user feel satisfied.

Also, in the aforementioned embodiment, when the mobile terminal 10 is shifted to the open position, the image that is being displayed on the display 26 is switched, but the present invention is not restricted to such a case. For example, when the mobile terminal 10 is shifted to the closed position, the image that is being displayed on the display 26 may be switched, or when the mobile terminal 10 is shifted from the open position or the closed position by the predetermined number of times, the image that is being displayed on the display 26 may be switched. In addition, every time that the mobile terminal 10 is shifted to the open position or the closed position, the image that is being displayed on the display 26 may be switched. That is, the user can quickly switch the image that is being displayed on the display 26 by merely switching the mobile terminal 10 between the open position and the closed position.

Furthermore, the mobile terminal 10 of the present embodiment takes a slidable shape, and the display 26 is always exposed, and therefore, the user can switch the displayed image irrespective of the closed or opened position of the mobile terminal 10.

In addition, the data capacity of the cache 30a of the present embodiment is about 4 MB, but the cache 30a of any data capacity is usable if only it is able to store two or more sets of display data, without being restricted to 4 MB. Thus, the number of display data to be stored may not be restricted to four. Also, the number of display data to be stored in the setting folder may not be restricted to five.

Also, the image data to be stored in the flash memory 28 may be data in Windows (registered trademark) bitmap format, in GIF format and in PING format, etc. without being restricted to data in JPEG format.

Furthermore, the expansion of the image data may be software decoding by the processor 20, or may be hardware decoding by an LSI, etc.

Additionally, as data to be stored in the cache 30a, data in the Flash format, data in a plurality of GIF formats, etc. are also stored. For example, in a case that a Flash animation is set to be displayed during the standby condition, data in Flash format is stored in the cache 30a.

Moreover, the mobile terminal 10 of the present embodiment is a slidable type, but a foldable type and a revolver type may be possible. Also, as to the slidable type, three or more cases may be slid without being restricted to the two cases.

In addition, as a communication system of the mobile terminal 10, a W-CDMA system, a GSM system, a TDMA system, a FDMA system, a PHS system, etc. may be adopted without being restricted to the CDMA system. In addition, an LCD monitor is utilized for the display 26, but other display devices, such as an organic electroluminescence panel may be utilized. The present application may be applied to electronic devices, such as a portable music audio player, a PDA (Personal Digital Assistant), a notebook-sized PC (including a netbook, or the like), etc. without being restricted to only the mobile terminal 10.

It should be noted that all the concrete numerical values of the number of pixels, the date and time, “number” of the list, the number of cache areas and the number of the order, etc. depicted in the specification are all simple examples, and are changeable as necessary depending on the specification of the products.

Although the present invention has been described and illustrated in detail, it is clearly understood that the same is by way of illustration and example only and is not to be taken by way of limitation, the spirit and scope of the present invention being limited only by the terms of the appended claims.

### EXPLANATION OF REFERENCE CHARACTERS

10 . . . mobile terminal
20 . . . processor
26 . . . display
28 . . . flash memory
30a . . . cache

What is claimed is:

1. A mobile terminal having a storage for storing a plurality of image data and a displayer for displaying images, and displaying said plurality of image data on the basis of a list representing a displaying order of said plurality of image data, comprising:
a setter which randomly sets the displaying order of said plurality of image data such that each of said plurality of image data is selected once; and
a creator which creates said list on the basis of the displaying order set by said setter.

2. A mobile terminal according to claim 1, wherein
said setter includes a first setter which sets to prevent a number that stands last on a list previously created from being set to a first on a list currently created and a second setter which sets said displaying order such that each of said plurality of image data is selected from numbers other than the number set by said first setter.

3. A storage medium storing, readably to a processor of a mobile terminal, a list creating program of said mobile terminal having a storage for storing a plurality of image data and a displayer for displaying images, and displaying said plurality of image data on the basis of a list representing a displaying order of said plurality of image data, said list creating program causes said processor to function as:
a setter which randomly sets the displaying order of said plurality of image data such that each of said plurality of image data is selected once; and
a creator which creates said list on the basis of the displaying order set by said setter.

4. A list creating method of a mobile terminal having a storage for storing a plurality of image data and a displayer for displaying images, and displaying said plurality of image data on the basis of a list representing a displaying order of said plurality of image data, comprising:
randomly setting the displaying order of said plurality of image data such that each of said plurality of image data is selected once; and
creating said list on the basis of the displaying order.
